(19) United States
(12) Patent Application Publication
(10) Pub. No.: US 2018/0113840 A1
(43) Pub. Date: Apr. 26, 2018

(54) Matrix Processor with Localized Memory

(71) Applicant: Wisconsin Alumni Research Foundation, Madison, WI (US)

(72) Inventors: Jing Li, Madison, WI (US); Jialiang Zhang, Madison, WI (US)

(21) Appl. No.: 15/333,696

(22) Filed: Oct. 25, 2016

(51) Int. Cl. G06F 15/80; G06F 13/28; G06F 3/06

(52) U.S. Cl. CPC G06F 15/80; G06F 13/28; G06F 3/0683; G06F 3/0647; G06F 3/0613

(57) ABSTRACT

A computer architecture provides for multiple processing elements arranged in logical rows and columns to share local memory associated with each column and row. This sharing of memory on a row and column basis provides for efficient matrix operations such as matrix multiplications such as can be used in a variety of processing algorithms to reduce dataflow between external memory and the local memories and/or to reduce the size of necessary local memories for efficient processing.

### STATEMENT REGARDING FEDERALLY SPONSORED RESEARCH OR DEVELOPMENT

--

### CROSS REFERENCE TO RELATED APPLICATION

--

### BACKGROUND OF THE INVENTION

The present invention relates to a computer architecture for high-speed matrix operations and in particular to a matrix processor providing local memory reducing the memory bottleneck between external memory and local memory for matrix type calculations.

Matrix calculations such as matrix multiplication are foundational to a wide range of emerging computer applications, for example, machine learning, and image processing which use mathematical kernel functions such as convolution over multiple dimensions.

The parallel nature of matrix calculations cannot be fully exploited by a conventional general-purpose processor and accordingly there is interest in developing a specialized matrix accelerator, for example, using field programmable gate arrays (FPGAs) to perform matrix calculations. In such designs, different processing elements of the FPGA could simultaneously process different matrix elements using portions of the matrix loaded into local memory associated with each processing element.

### SUMMARY OF THE INVENTION

The present inventors have recognized that there is a severe memory bottleneck in the transfer of matrix data between external memory and the local memory of FPGA type architectures. This bottleneck results from both the limited size of local memory compared to the computing resources of the FPGA type architecture and from delays inherent in repeated transfer of data from external memory to local memory. The present inventors have further recognized that computational resources are growing much faster than local memory resources exacerbating this problem.

The present invention addresses this problem by sharing data stored in a given local memory resource normally associated with a given processing unit among multiple processing units. The sharing may be in a pattern following the logical interrelationship of a matrix calculation (e.g., along rows and columns in one or more dimensions of the matrix). This sharing reduces memory replication (the need to store a given value in multiple local memory locations) thus both reducing the need for local memory and unnecessary transfers of data between local memory and external memory greatly speeding the calculations and/or reducing energy consumption associated with the calculation.

Specifically, the invention provides a computer architecture for matrix calculation including a set of processing elements each arranged in logical rows and logical columns to receive operands along first and second data lines. The first data lines each connect to multiple processing elements of each logical row and the second data lines each connect to logical processing elements of logical columns. Local memory elements are associated with each of the first and second data lines to provide given operands simultaneously to each processing element interconnected by the first and second data lines. A dispatcher transfers data from an external memory to the local memory elements and sequentially applies operands stored in the local memory elements to the first and second data lines to implement a matrix calculation using the operands.

It is thus a feature of at least one embodiment of the invention to provide an architecture that shares operand values from local memory among multiple processing elements to eliminate a memory transfer bottleneck between external memory and local memories recognized by the present inventors to present a limiting factor in matrix-type calculations.

Generally, the local memory elements are on a single integrated circuit substrate also holding the processing elements and may be distributed over the integrated circuit so that each given local memory is proximate to a corresponding given processing element.

It is thus a feature of at least one embodiment of the invention to permit the high-speed processing possible with local memories (on-chip memory) while accommodating the limited amount of local memory that is available and time delays required to refresh local memory from external memory.

The processing elements may be interconnected by a programmable interconnection structure, for example, of a type provided by a field programmable gate array.

It is thus a feature of at least one embodiment of the invention to provide ready implementation of the architecture of the present invention in an FPGA type device.

The architecture may provide at least eight logical rows and eight logical columns.

It is thus a feature of at least one embodiment of the invention to provide a scalable architecture allowing multicolumn, multirow, parallel matrix multiplication operations reducing the number of decompositions necessary for matrix operations on much larger matrices.

The processing elements are distributed in two dimensions over the surface of an integrated circuit in physical rows and columns.

It is thus a feature of at least one embodiment of the invention to provide a structure that mimics the arithmetic operation of a matrix operation thereby reducing interconnection distances.

The architecture may include a crossbar switch controlled by the dispatcher to provide a programmable sorting of the data received from the external memory as transferred into the local memory elements associated with particular of the first and second data lines, the programmable sorting adapted to implement a matrix calculation.

It is thus a feature of at least one embodiment of the invention to permit data reordering at the integrated circuit level for flexible application of the architecture to a variety of different matrix sizes and matrix related operations.

The processing elements may provide a multiplication operation.

It is thus a feature of at least one embodiment of the invention to provide a specialized architecture useful for a foundational calculation used in many applications including image processing, machine learning, and the like.

The processing elements may employ a lookup table multiplier.

It is thus a feature of at least one embodiment of the invention to provide a simple multiplier design that can be readily implemented for many processing elements for a large matrix multiplication architecture.

The architecture may include an accumulator summing outputs from the processing elements between sequential applications of data values to the processing elements from the local memory elements.

It is thus a feature of at least one embodiment of the invention to provide a summing of processing element outputs between sequential parallel multiplications to implement a matrix multiplication.

The computer architecture may include an output multiplexer transferring data from the accumulator to external memory as controlled by the dispatcher.

It is thus a feature of at least one embodiment of the invention to permit flexible reordering of the outputs of the accumulator to be compatible with storage data structures used in the external memory.

These particular objects and advantages may apply to only some embodiments falling within the claims and thus do not define the scope of the invention.

### BRIEF DESCRIPTION OF THE DRAWINGS

FIG. 1 is a simplified diagram of an integrated circuit layout for a field programmable gate array that may be used with the present invention showing processing elements, local memory associated with the processing elements, and interconnection circuitry and depicting a dataflow between the local memory and external memory such as represents a limiting factor in calculations performed by the processing elements;

FIG. 2 is a diagram of a prior art association of local memory and processing elements without data sharing;

FIG. 3 is a diagram similar to FIG. 2 showing in simplified form the association between local memory and processing elements of the present invention that shares data in each local memory among multiple processing elements reducing memory transfers needed for matrix operations and/or the necessary size of local memory;

FIG. 4 is a figure similar to FIG. 3 showing an implementation of the present architecture in greater detail such as provides a dispatcher controlling a crossbar switch to transfer data to the local memories in a way advantageous for matrix operation and an accumulator useful for matrix multiplication and an output multiplexer for outputting that data to the external memory;

FIG. 5 is a depiction of a simple example of the present invention used to multiply two 2×2 matrices showing a first calculation step; and

FIG. 6 is a figure similar to FIG. 5 showing a second step in the calculation completing the matrix multiplication.

### DETAILED DESCRIPTION OF THE PREFERRED EMBODIMENT

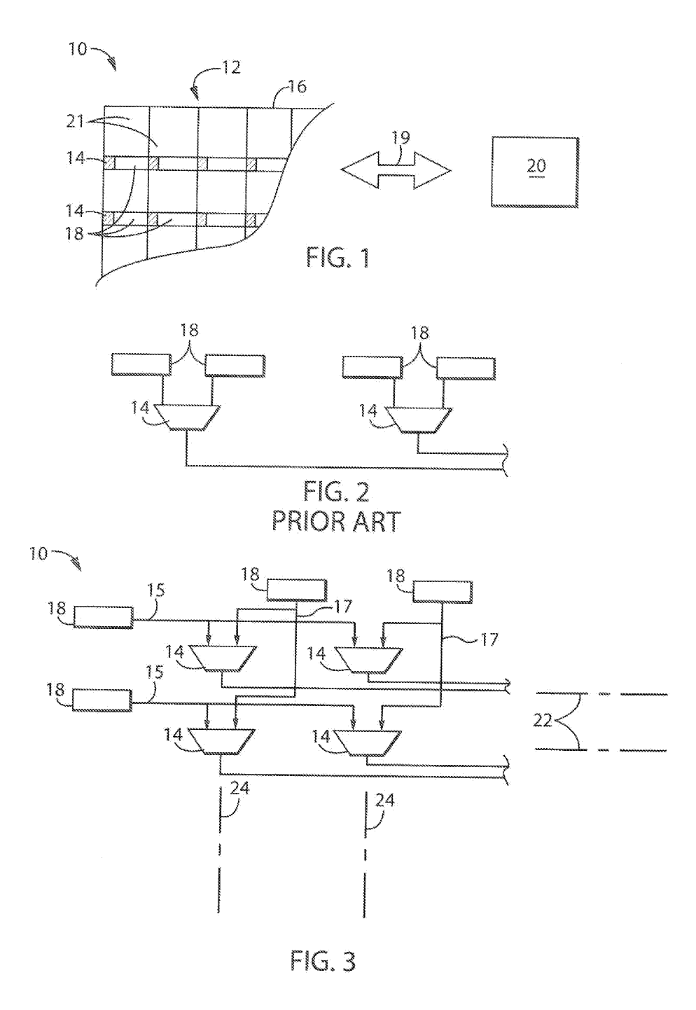

Referring now to FIG. 1, a matrix processor 10 per the present invention, in one embodiment, may be implemented on a field programmable gate array (FPGA) 12. As is generally understood in the art, the FPGA 12 may include multiple processing elements 14, for example, distributed over the surface of a single integrated circuit substrate 16 in orthogonal rows and columns. The processing elements 14 may implement simple Boolean functions or more complex arithmetic functions such as multiplication, for example, using lookup tables or by using digital signal processor (DSP) circuitry. In one example, each processing element 14 may provide a multiplier operating to multiply two 32-bit operands together.

Local memory elements 18 may also be distributed over the integrated circuit substrate 16 clustered near each of the processing elements. In one example, each local memory element 18 may store 512 32-bit words to supply 32-bit operands to the processing element 14. Generally the amount of local memory element 18 per processing element 14 is limited and therefor is a significant constraint on the speed of data flow 19 between the local memory elements 18 and external memory 20, a constraint that is exacerbated if the local memory elements 18 must be frequently refreshed during a calculation.

Generally the external memory 20 will be dynamic memory (e.g., DRAM) having much greater capacity than the local memory elements 18 and located off of the integrated circuit substrate 16. In contrast to the external memory 20, the local memory elements 18 may be static memory.

The processing elements 14 are interconnected with each other and with input and output circuitry (not shown) of the FPGA 12 by interconnection circuitry 21, the latter providing routing of data and/or control signals between the processing elements 14 according to a configuration of the FPGA 12. As is understood in the art, the interconnection circuitry 21 may be programmably altered (for example, using the configuration file applied during boot up) to provide for different interconnections implementing different functions from the FPGA 12. Generally, the interconnection circuitry 21 dominates the area of the integrated circuit substrate 16. While the present invention is particularly suited to FPGA architectures, the architecture of the present invention may also be implemented in a dedicated circuit such as would reduce the interconnection circuitry 21.

Referring now to FIG. 2, prior art implementations of architectures for FPGA 12 generally associate each processing element 14 uniquely with memory elements 18 closest to that processing element 14. In this association, the local memory elements 18 store multiple operands that can be provided sequentially to the processing elements 14 before the data of the local memory elements 18 needs to be exchanged or refreshed.

Referring now to FIG. 3, in contrast to the prior art association of each memory element 18 with a single processing element 14, the present invention allows multiple processing elements 14 to receive in parallel data from a single given local memory element 18 which is associated with either a logical row 22 or a logical column 24 along which multiple processing elements 14 are connected. Each processing element 14 receives one operand from one row conductor 15 associated with that processing element 14 and one operand from a column conductor 17 associated with that processing element 14. Further, all of the processing elements 14 in one row receive an identical operand and all the processing elements 14 in one column received one identical operand. Generally the row conductors 15 and the column conductors 17 provide substantially instantaneous transmission of data to each of the processing elements 14 and may be a single electrical conductor or an electrical conductor with repeater or fanout amplifiers as needed to provide the necessary length and frequency response consistent with signal transmissions in excess of 100 megahertz.

While logical rows 22 and logical columns 24 refer only to the connection topology, generally the processing elements 14 will also be in physical rows and columns comporting with the architecture of the FPGA 12 and minimizing their interconnection distances.

As will be understood in the discussion below, this ability to share data from a given local memory element 18 with multiple processing elements 14 allows the architecture of the present invention to advantageously work in matrix operations such as matrix multiplication where a given data value is needed by multiple processing elements 14. Sharing data of the local memory elements 18 reduces storage demands (the amount of local memory needed) and reduces the amount of data flowing between the external memory 20 and the local memory elements 18 compared to what would flow if the shared data were stored redundantly in multiple local memory elements 18.

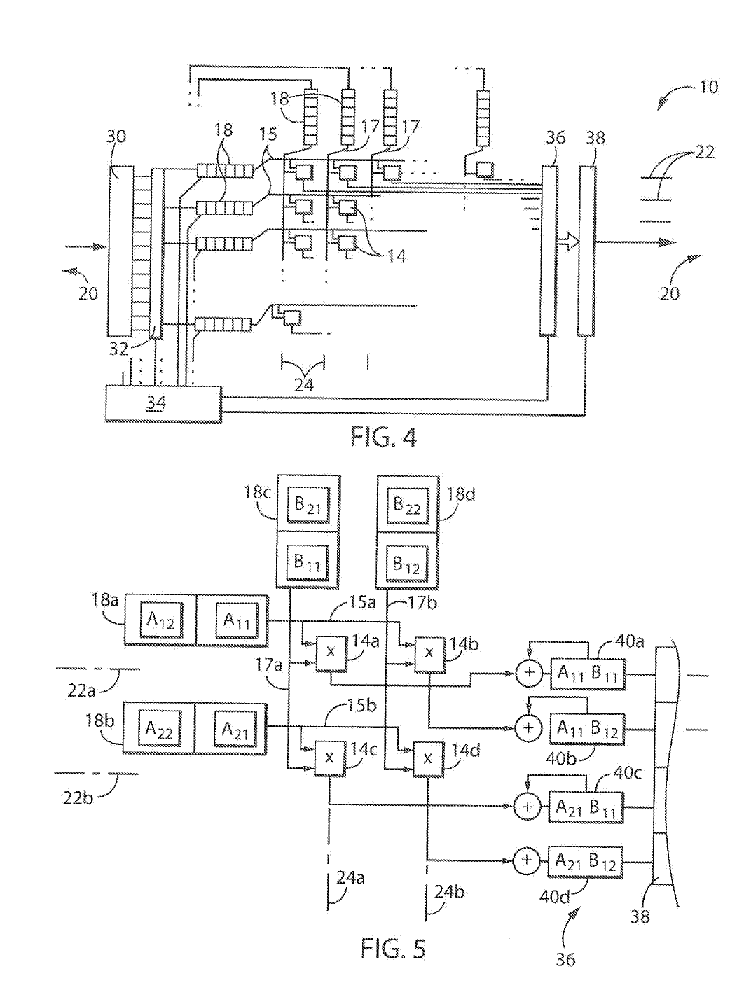

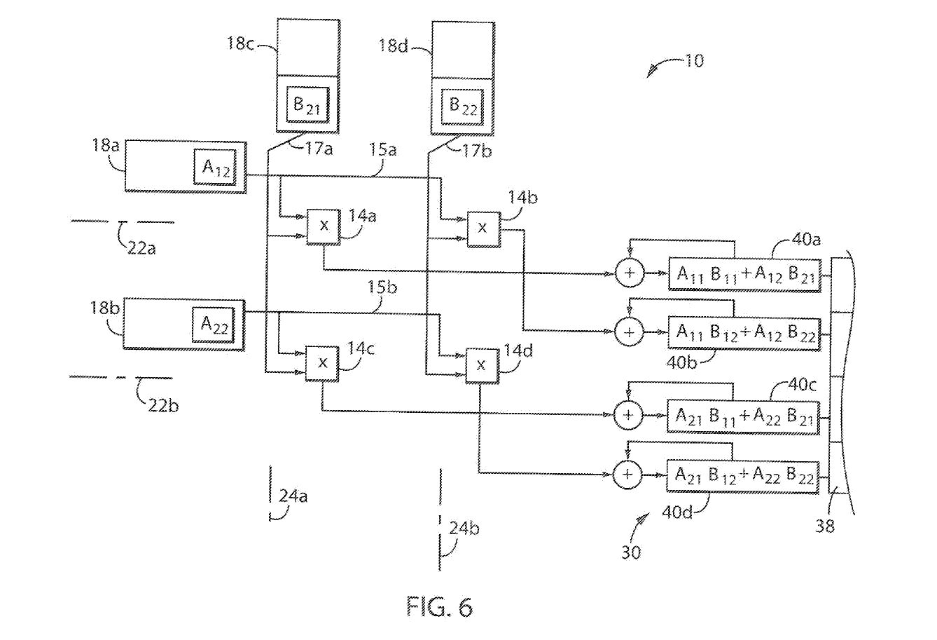

Referring now to FIG. 4, in addition to the local memory elements 18 and the processing elements 14, as interconnected by the row conductors 15 and column conductor 17, matrix processor 10 may generally include an input buffer 30 for receiving data from the external memory 20. This data may be received through a variety of different interfaces including, for example, a PCIe controller or one or more DDR controllers of types known in the art.

The data may be received into the input buffer 30 in a sequence associated with a matrix operation data structure held in memory 20 of arbitrary configuration and then may be switched by a crossbar switch 32 controlled by a dispatcher 34 to load each of the multiple local memory elements 18 associated with logical rows and logical columns necessary for the calculation that will be described. In this transfer process, the dispatcher 34, for example, may place one matrix operand in local memory elements 18 associated with rows 22 and the second matrix operand in local memory elements 18 associated with the columns 24 as will be explained in more detail below.

As mentioned, the processing elements 14 may be arranged in logical rows and columns having dimensions (numbers of rows or numbers of columns) equal to or greater than eight rows and eight columns to permit the matrix multiplication of two 8×8 matrices although larger dimensions (and non-square) dimensions may also be provided.

During operation, the dispatcher will sequence the local memory elements 18 to output different operand values to the respective rows and columns of processor elements 14. After each sequence of providing operand values to the processor elements 14, output from the processor elements 14 are provided to an accumulator 36 also under control of the dispatcher 34. An output multiplexer 38 collects the outputs of the accumulator 36 into words that may be transmitted again to the external memory 20.

Referring now to FIGS. 4 and 5, the ability to share local memory among multiple processor elements 14 will now be applied in a simple example to the multiplication of a 2×2 matrix A with a corresponding 2×2 matrix B of the following form:

$$A = [ \begin{matrix}{A}_{11} & {A}_{12} \\ {A}_{21} & {A}_{22}\end{matrix} ]$$

$$B = [ \begin{matrix}{B}_{11} & {B}_{12} \\ {B}_{21} & {B}_{22}\end{matrix} ] .$$

At a first step, the matrix elements (e.g., Aᵢᵢ and Bᵢᵢ) of the matrices A and B are loaded from the external memory into the local memory elements 18 by the dispatcher 34 using the crossbar switch 32. In particular, the first row of matrix A will be loaded into first local memory element 18a associated with first row 22a and row conductor 15a, and the second row of matrix A will be loaded into second local memory element 18b associated with second row 22b and row conductor 15b. Likewise, the first column of matrix B will be loaded into third local memory element 18c associated with first column 24a and column conductor 17a, and the second column of matrix B will be loaded into fourth local memory element 18d associated with second column 24b and column conductor 17b.

In a first stage of the matrix multiplication, the dispatcher 37 addresses the local memory elements 18 to output matrix elements of the first column matrix A and the first row of matrix B along the row conductors 15 and column conductor 17 to the processor elements 14.

The processing elements 14 will be configured for multiplication of the received operands from the local memory elements 18 resulting in an output from processing element 14a and 14b of A₁₁B₁₁ and A₁₁B₁₂, respectively, and an outputting from processing elements 14c and 14d of A₂₁B₁₁ and A₂₁B₁₂. Each of these outputs is stored in a respective register 40a-40d of the accumulator 36 which for the purpose of this example have the same suffix letter as a suffix letter of the respective processing element 14 from which the data is received. Accordingly registers 40a and 40b hold values A₁₁B₁₁ and A₁₁B₁₂, respectively, and registers 40c and 40d hold values A₂₁B₁₁ and A₂₁B₁₂ respectively.

At a second stage of the matrix multiplication, the dispatcher 37 addresses the local memory elements 18 to output matrix elements of the second column matrix A and the second row of matrix B along the row conductors 15 and column conductor 17 to the processor elements 14.

In response, the processing elements 14a and 14b will provide outputs A₁₂B₂₁ and A₁₂B₂₂, respectively, whereas processing elements 14c and 14d provide outputs A₂₂B₂₁ and A₂₂B₂₂, respectively. The accumulator 36 sums each of these output values with the previously stored values in a respective accumulator register 40a-40d to provide new values in each of registers 40a-40d as follows: A₁₁B₁₁+A₁₂B₂₁, A₁₁B₁₂+A₁₂B₂₂, A₂₁B₁₁+A₂₂B₂₁, A₂₁B₁₂+A₂₂B₂₂ respectively in the registers 40a-40d.

The values in the registers will be recognized as a result to be expected in a matrix multiplication of matrices AB as follows:

$$AB = [ \begin{matrix}{A}_{11} {B}_{11} + {A}_{12} {B}_{21} & {A}_{11} {B}_{12} + {A}_{12} {B}_{22} \\ {A}_{21} {B}_{11} + {A}_{22} {B}_{21} & {A}_{21} {B}_{12} + {A}_{22} {B}_{22}\end{matrix} ] .$$

These values may then be sorted by the multiplexer 38 and provided to the external memory 20 in a desired data format as a result of the matrix multiplication operation. It will be appreciated that this above described process may be readily expanded to a matrix of any dimensional size by increasing the number of processing elements 14 and their associated local memory elements 18 and accumulator registers 40.

A fixed size array of processor elements 14 (for example, 8×8 or larger) can be used to compute arbitrary matrix multiplications of arbitrarily large matrices by using the well-known “divide and conquer” technique which breaks the matrix multiplication of large matrix operands into a set of matrix multiplications of smaller matrix operands compatible with the matrix processor 10.

The dispatcher 34 may include programming (e.g., firmware) to provide a necessary sorting of data into the local memory elements 18 from a standard ordering, for example, provided within external memory 20. In this regard the matrix processor 10 may operate as an independent processor or as a coprocessor, for example, receiving data or pointer from a standard computer processor to automatically execute the matrix operation and return the results to the standard computer processor.

While the dispatcher 34 may control the sorting of data from external memory 20 into the local memory elements 18, the sorting may also be handled by a combination of the dispatcher 34 and an operating system of a separate computer working in conjunction with the matrix processor 10.

It will be appreciated that many important computational tasks can be recast as matrix multiplication problems including, for example, convolutions, auto correlations, Fourier transforms, filtering, machine learning structures such as neural networks and the like. It will also be appreciated that the invention can be extended to matrix multiplication or other matrix operations in more than two dimensions simply by adding sharing paths along those multiple dimensions according to the teachings of the present invention has extended to multiple dimensions.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible local memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What we claim is:

1. The computer architecture for matrix calculation comprising:
a set of processing elements each arranged in one of a plurality of logical rows and one of a plurality of logical columns and each receiving a first and second operand along first and second data lines to provide an output result according to an operation of the processing element, wherein the first data lines each connect to multiple processing elements of each logical row of the plurality of logical rows and the second data lines each connect to logical processing elements of each logical column of the plurality of logical columns;
local memory elements associated with each of the first and second data lines to provide given operands simultaneously to each processing element interconnected by the first and second data lines; and
a dispatcher transferring data from an external memory to the local memory elements and sequentially applying operands stored in the local memory elements to the first and second data lines to implement a matrix calculation using the operands.

2. The computer architecture of claim 1 wherein the local memory elements are on a single integrated circuit substrate also holding the processing elements.

3. The computer architecture of claim 2 wherein the local memory elements are distributed over the integrated circuit.

4. The computer architecture of claim 3 wherein each given local memory is proximate to a corresponding given processing element.

5. The computer architecture of claim 4 wherein the processing elements are interconnected by a programmable interconnection structure.

6. The computer architecture of claim 5 wherein the integrated circuit is a field programmable gate array.

7. The computer architecture of claim 1 wherein the computer architecture provides at least eight logical rows and eight logical columns.

8. The computer architecture of claim 1 wherein the processing elements are distributed in two dimensions over the surface of an integrated circuit in physical rows and columns.

9. The computer architecture of claim 1 further including a crossbar switch controlled by the dispatcher to provide a programmable sorting of the data received from the external memory as transferred into the local memory elements associated with particular of the first and second data lines, the programmable sorting adapted to implement a matrix calculation.

10. The computer architecture of claim 1 wherein the processing elements provide a multiplication operation.

11. The computer architecture of claim 10 wherein the processing elements comprise a lookup table multiplier.

12. The computer architecture of claim 10 further including an accumulator summing outputs from the processing elements between sequential applications of data values to the processing elements from the local memory elements.

13. The computer architecture of claim 12 further including an output multiplexer transferring data from the accumulator to external memory as controlled by the dispatcher.

14. A method of implementing high-speed matrix multiplication using a multiplier architecture comprising:
a set of processing elements each arranged in one of a plurality of logical rows and one of a plurality of logical columns and each receiving a first and second operand along first and second data lines to provide an output result according to an operation of the processing element, wherein the first data lines each connect to multiple processing elements of each logical row of the plurality of logical rows and the second data lines each connect to logical processing elements of each logical column of the plurality of logical columns;
local memory elements associated with each of the first and second data lines to provide given operands simultaneously to each processing element interconnected by the first and second data lines; and
a dispatcher transferring data from an external memory to the local memory elements and sequentially applying operands stored in the local memory elements to the first and second data lines to implement a matrix calculation using the operands;
the method comprising the steps of:
(a) receiving matrix operands having matrix elements with arithmetic rows and arithmetic columns from the external memory and sorting the matrix elements into local memory elements so that matrix elements of a common arithmetic row of a first operand are loaded into local memory associated with one of the first data lines and matrix elements of a common arithmetic column of a second operand are loaded into local memory associated with one of the second data lines;
(b) sequentially applying matrix elements of given columns of the first operand and matrix elements of given rows of the second operand to the processing elements;
(c) summing outputs of the processing elements between sequential applications of step (b) to provide matrix elements of the matrix product; and
(d) outputting the matrix elements of the matrix product.

15. The method of claim 14 further including the step of transferring each of the matrix elements of the received matrix operands to local memory before application of the matrix elements to the processing elements.

16. The method of claim 14 further including the step of receiving data from the external memory into a buffer in a first order and sorting the data to a different order as it is transferred to the local memories.

17. The method of claim 14 wherein the local memory elements on a single integrated circuit substrate also hold the processing elements.

18. The method of claim 14 wherein the processing elements provide a multiplication operation.
